(19) United States
(12) Patent Application Publication
(10) Pub. No.: US 2025/0147992 A1
(43) Pub. Date: May 8, 2025

(54) OptiSenseGPT: Context-Aware Anomaly Detection with Natural Language Alerts and ActionableRecommendations for Distributed Fiber Optic Sensing Applications

(71) Applicant: NEC Laboratories America, Inc., Princeton, NJ (US)

(72) Inventors: Yangmin DING, East Brunswick, NJ (US); Ting WANG, West Windsor, NJ (US)

(73) Assignee: NEC Laboratories America, Inc., Princeton, NJ (US)

(21) Appl. No.: 18/935,495

(22) Filed: Nov. 2, 2024

Related U.S. Application Data
(60) Provisional application No. 63/595,835, filed on Nov. 3, 2023.

(51) Int. Cl. G06F 16/332; G06F 16/34

(52) U.S. Cl. CPC G06F 16/3329; G06F 16/345

(57) ABSTRACT

Disclosed are integrated systems and methods providing intelligent anomaly detection for DFOS systems and applications, the systems and methods utilizing a natural language processing model, such as ChatGPT, to generate real-time alerts with actionable recommendations and potential consequences based on detected anomalies. Our innovative solution—OptiSenseGPT—solves problems left uncured by traditional methods by delivering easily understandable alerts in natural language, enabling timely response by relevant personnel. Our integrated OptiSenseGPT systems and methods disclosed provide context-aware recommendations and consequences, enhancing decision-making and improving overall performance and safety of a monitored infrastructure or environment. Our OptiSenseGPT systems and methods advantageously provide integration of natural language processing; context-aware recommendations; presentation of potential consequences; adaptability and customization; and seamless integration.

### CROSS-REFERENCE TO RELATED APPLICATIONS

This application claims the benefit of U.S. Provisional Patent Application Ser. No. 63/595,835 filed Nov. 3, 2023, the entire contents of which is incorporated by reference as if set forth at length herein.

### FIELD OF THE INVENTION

This application relates generally to distributed fiber optic sensing (DFOS) systems, methods, structures, and related technologies. More particularly, it pertains to context-aware anomaly detection with natural language alerts and actionable recommendations for DFOS applications.

### BACKGROUND OF THE INVENTION

Distributed fiber optic sensing (DFOS) systems, methods, and structures have found widespread utility in contemporary industry and society. Of particular importance, DFOS techniques have been used to usher in a new era of monitoring including perimeter security, traffic monitoring, and civil infrastructure monitoring. They can provide continuous, real-time measurements over long distances with high sensitivity, making them valuable tools for infrastructure monitoring and maintenance.

However, analyzing data generated by DFOS systems and identifying anomalies in real-time can be challenging. The large volume of data collected, combined with the complexity of the physical processes being monitored, make it difficult for human operators to detect and diagnose issues in a timely manner. Existing methods, including traditional GUI-based real-time alert systems, may not provide clear or easily understandable information, actionable recommendations, or potential consequences related to the detected anomalies.

For example, in a pipeline monitoring application, a distributed fiber optic sensing system might detect an abnormal temperature increase at a specific location, potentially indicating a leak. In a traditional GUI-based alert system, this information might be presented through visual elements such as graphs or charts, which require interpretation by a user. Furthermore, the system might not provide information about the potential consequences of the leak, such as environmental damage or safety hazards, nor suggest appropriate actions to address the issue.

Therefore, there exists a continuing need for an automated, intelligent solution that can detect anomalies, provide real-time alerts with actionable recommendations and consequences, and facilitate timely response by the relevant personnel.

### SUMMARY OF THE INVENTION

The above problems are solved and an advance in the art is made according to aspects of the present disclosure directed to systems and methods providing intelligent anomaly detection for DFOS systems and applications.

In sharp contrast to the prior art, systems and methods according to aspects of the present disclosure utilize a natural language processing model, such as ChatGPT, to generate real-time alerts with actionable recommendations and potential consequences based on detected anomalies. Our innovative solution—OptiSenseGPT—solves the noted problems left uncured by traditional methods by delivering easily understandable alerts in natural language, enabling timely response by relevant personnel.

Advantageously, systems and methods according to aspects of the present disclosure advance the state of the art by providing context-aware recommendations and consequences, enhancing decision-making and improving overall performance and safety of a monitored infrastructure or environment.

As we shall show and describe particularly inventive features of our OptiSenseGPT systems and methods according to aspects of the present disclosure include the following.

Integration of natural language processing: OptiSenseGPT systems and methods according to the present disclosure incorporate a natural language processing model, such as ChatGPT, which enables the generation of real-time alerts in easily understandable natural language, improving communication with users and reducing the need for domain-specific expertise.

Context-aware recommendations: OptiSenseGPT systems and methods according to the present disclosure provide actionable recommendations tailored to the detected anomalies, taking into account the specific application and domain. This facilitates quick and informed decision-making by relevant personnel, enhancing the efficiency of response actions.

Presentation of potential consequences: OptiSenseGPT systems and methods according to the present disclosure identifies and communicates the potential consequences of detected anomalies, raising awareness of potential risks and encouraging timely intervention to prevent or mitigate negative impacts on the monitored infrastructure.

Adaptability and customization: OptiSenseGPT systems and methods according to the present disclosure can be adapted to various distributed fiber optic sensing applications and domains, with the capability to incorporate advanced machine learning models or deep learning techniques tailored to specific use cases.

Seamless integration: OptiSenseGPT systems and methods according to the present disclosure support integration with existing alert management systems, incident response platforms, or communication channels, ensuring compatibility with existing infrastructure and facilitating the implementation process.

These—and other—inventive features work together to create an intelligent anomaly detection solution for distributed fiber optic sensing applications, ultimately enhancing the overall performance, safety, and decision-making processes associated with the monitored infrastructure.

### BRIEF DESCRIPTION OF THE DRAWING

FIG. 1(A) and FIG. 1(B) are schematic diagrams showing an illustrative prior art uncoded and coded DFOS systems.

FIG. 2(A)-FIG. 2(F) are a series of schematic flow diagrams showing illustrative operational steps of systems and methods according to aspects of the present disclosure.

FIG. 3 is a schematic flow diagram showing illustrative data pre-preprocessing and feature extraction operational flow of systems and methods according to aspects of the present disclosure.

FIG. 4 is a schematic flow diagram showing illustrative anomaly detection and localization operational flow of systems and methods according to aspects of the present disclosure.

FIG. 5 is a schematic flow diagram showing illustrative contextual information integration operational flow of systems and methods according to aspects of the present disclosure.

FIG. 6 is a schematic flow diagram showing illustrative natural language processing using ChatGPT flow of systems and methods according to aspects of the present disclosure.

FIG. 7 is a schematic flow diagram showing illustrative adaptive natural language processing using ChatGPT flow of systems and methods according to aspects of the present disclosure.

FIG. 8 is a schematic flow diagram showing illustrative alert delivery and communication with ChatGPT-generated natural language alerts flow of systems and methods according to aspects of the present disclosure.

FIG. 9 is a schematic flow diagram showing illustrative continuous learning and improvement for OptiSenseGPT System flow of systems and methods according to aspects of the present disclosure.

FIG. 10 is a schematic diagram showing illustrative feature hierarchy systems and methods according to aspects of the present disclosure.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we note that distributed fiber optic sensing systems convert the fiber to an array of sensors distributed along the length of the fiber. In effect, the fiber becomes a sensor, while the interrogator generates/injects laser light energy into the fiber and senses/detects events along the fiber length.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and—depending on system configuration—can be deployed in continuous lengths exceeding 30 miles with sensing/detection at every point along its length. As such, cost per sensing point over great distances typically cannot be matched by competing technologies.

Distributed fiber optic sensing measures changes in “backscattering” of light occurring in an optical sensing fiber when the sensing fiber encounters environmental changes including vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

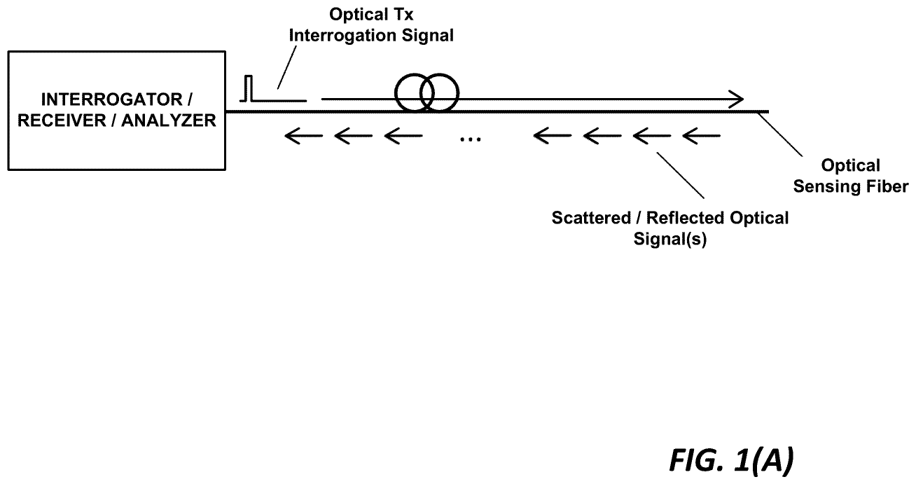

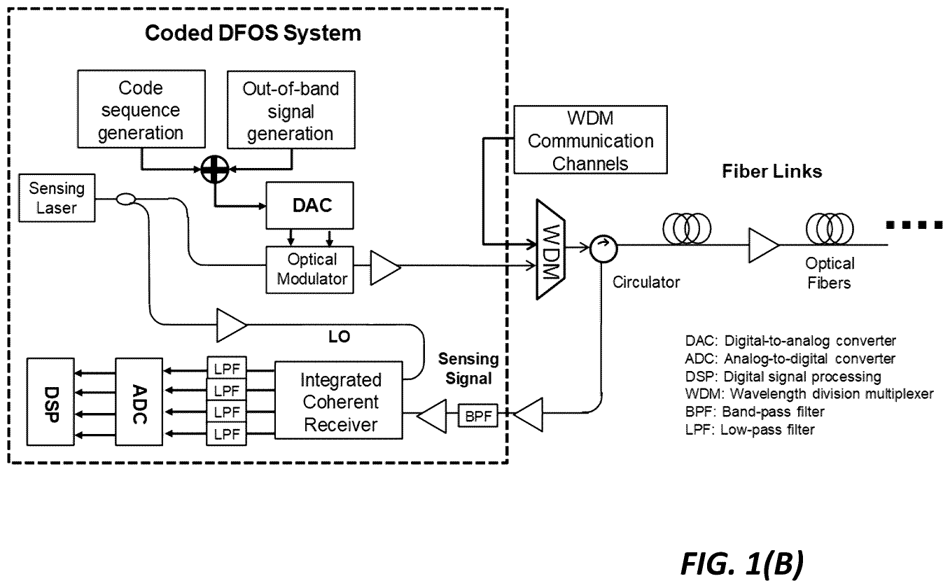

A schematic diagram illustrating the generalized arrangement and operation of a distributed fiber optic sensing system that may advantageously include artificial intelligence/machine learning (AI/ML) analysis is shown illustratively in FIG. 1(A). With reference to FIG. 1(A), one may observe an optical sensing fiber that in turn is connected to an interrogator. While not shown in detail, the interrogator may include a coded DFOS system that may employ a coherent receiver arrangement known in the art such as that illustrated in FIG. 1(B).

As is known, contemporary interrogators are systems that generate an input signal to the optical sensing fiber and detects/analyzes reflected/backscattered and subsequently received signal(s). The received signals are analyzed, and an output is generated which is indicative of the environmental conditions encountered along the length of the fiber. The backscattered signal(s) so received may result from reflections in the fiber, such as Raman backscattering, Rayleigh backscattering, and Brillion backscattering.

As will be appreciated, a contemporary DFOS system includes the interrogator that periodically generates optical pulses (or any coded signal) and injects them into an optical sensing fiber. The injected optical pulse signal is conveyed along the length optical fiber.

At locations along the length of the fiber, a small portion of signal is backscattered/reflected and conveyed back to the interrogator wherein it is received. The backscattered/reflected signal carries information the interrogator uses to detect, such as a power level change that indicates—for example—a mechanical vibration.

The received backscattered signal is converted to electrical domain and processed inside the interrogator. Based on the pulse injection time and the time the received signal is detected, the interrogator determines at which location along the length of the optical sensing fiber the received signal is returning from, thus able to sense the activity of each location along the length of the optical sensing fiber. Classification methods may be further used to detect and locate events or other environmental conditions including acoustic and/or vibrational and/or thermal along the length of the optical sensing fiber.

Of particular interest, distributed acoustic sensing (DAS) is a technology that uses fiber optic cables as linear acoustic sensors. Unlike traditional point sensors, which measure acoustic vibrations at discrete locations, DAS can provide a continuous acoustic/vibration profile along the entire length of the cable. This makes it ideal for applications where it's important to monitor acoustic/vibration changes over a large area or distance.

Distributed acoustic sensing/distributed vibration sensing (DAS/DVS), also sometimes known as just distributed acoustic sensing (DAS), is a technology that uses optical fibers as widespread vibration and acoustic wave detectors. Like distributed temperature sensing (DTS), DAS/DVS allows for continuous monitoring over long distances, but instead of measuring temperature, it measures vibrations and sounds along the fiber.

DAS/DVS operates as follows.

Light pulses are sent through the fiber optic sensor cable.

As the light travels through the cable, vibrations and sounds cause the fiber to stretch and contract slightly.

These tiny changes in the fiber's length affect how the light interacts with the material, causing a shift in the backscattered light's frequency.

By analyzing the frequency shift of the backscattered light, the DAS/DVS system can determine the location and intensity of the vibrations or sounds along the fiber optic cable.

Similar to DTS, DAS/DVS offers several advantages over traditional point-based vibration sensors: High spatial resolution: It can measure vibrations with high granularity, pinpointing the exact location of the source along the cable; Long distances: It can monitor vibrations over large areas, covering several kilometers with a single fiber optic sensor cable; Continuous monitoring: It provides a continuous picture of vibration activity, allowing for better detection of anomalies and trends; Immune to electromagnetic interference (EMI): Fiber optic cables are not affected by electrical noise, making them suitable for use in environments with strong electromagnetic fields.

DAS/DVS technology has a wide range of applications, including: Structural health monitoring: Monitoring bridges, buildings, and other structures for damage or safety concerns; Pipeline monitoring: Detecting leaks, blockages, and other anomalies in pipelines for oil, gas, and other fluids; Perimeter security: Detecting intrusions and other activities along fences, pipelines, or other borders; Geophysics: Studying seismic activity, landslides, and other geological phenomena; and Machine health monitoring: Monitoring the health of machinery by detecting abnormal vibrations indicative of potential problems.

With the above in mind, we note again that in sharp contrast to the prior art, systems and methods according to aspects of the present disclosure utilize a natural language processing model, such as ChatGPT, to generate real-time alerts with actionable recommendations and potential consequences based on detected anomalies. Our innovative solution—OptiSenseGPT—solves the noted problems left uncured by traditional methods by delivering easily understandable alerts in natural language, enabling timely response by relevant personnel.

Advantageously, systems and methods according to aspects of the present disclosure advance the state of the art by providing context-aware recommendations and consequences, enhancing decision-making and improving overall performance and safety of a monitored infrastructure or environment.

As we shall show and describe particularly inventive features of our OptiSenseGPT systems and methods according to aspects of the present disclosure include the following.

Integration of natural language processing: OptiSenseGPT systems and methods according to the present disclosure incorporate a natural language processing model, such as ChatGPT, which enables the generation of real-time alerts in easily understandable natural language, improving communication with users and reducing the need for domain-specific expertise.

Context-aware recommendations: OptiSenseGPT systems and methods according to the present disclosure provide actionable recommendations tailored to the detected anomalies, taking into account the specific application and domain. This facilitates quick and informed decision-making by relevant personnel, enhancing the efficiency of response actions.

Presentation of potential consequences: OptiSenseGPT systems and methods according to the present disclosure identifies and communicates the potential consequences of detected anomalies, raising awareness of potential risks and encouraging timely intervention to prevent or mitigate negative impacts on the monitored infrastructure.

Adaptability and customization: OptiSenseGPT systems and methods according to the present disclosure can be adapted to various distributed fiber optic sensing applications and domains, with the capability to incorporate advanced machine learning models or deep learning techniques tailored to specific use cases.

Seamless integration: OptiSenseGPT systems and methods according to the present disclosure support integration with existing alert management systems, incident response platforms, or communication channels, ensuring compatibility with existing infrastructure and facilitating the implementation process.

These—and other—inventive features work together to create an intelligent anomaly detection solution for distributed fiber optic sensing applications, ultimately enhancing the overall performance, safety, and decision-making processes associated with the monitored infrastructure.

The OptiSenseGPT system is a complex solution that integrates ChatGPT with distributed fiber optic sensing systems to provide comprehensive, context-aware natural language alerts. The process involves eight steps:

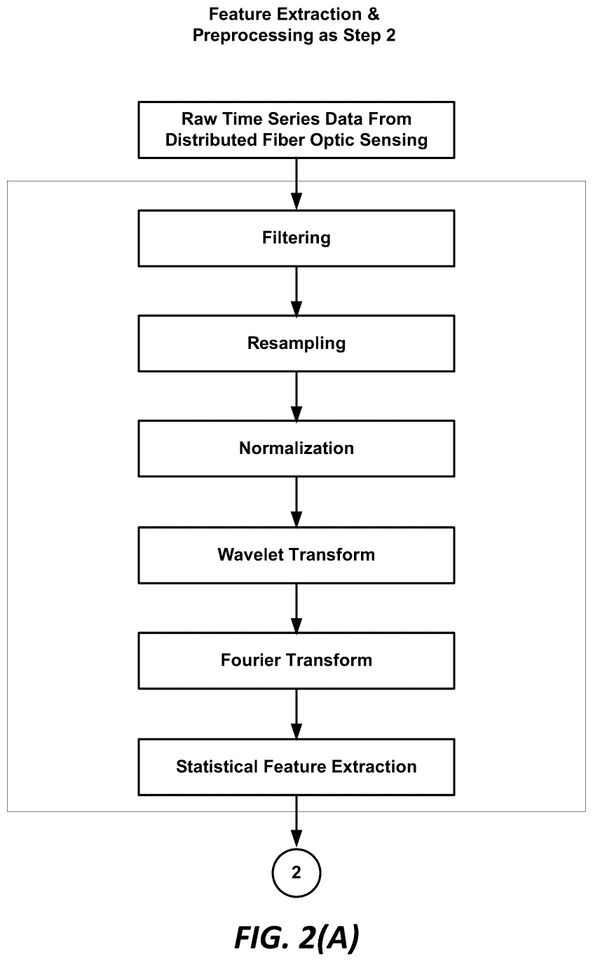

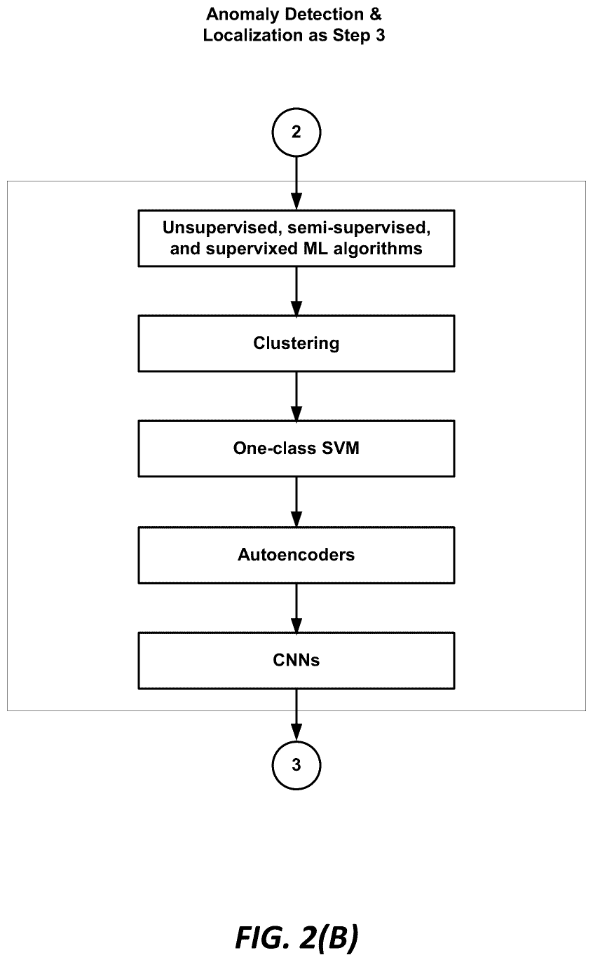

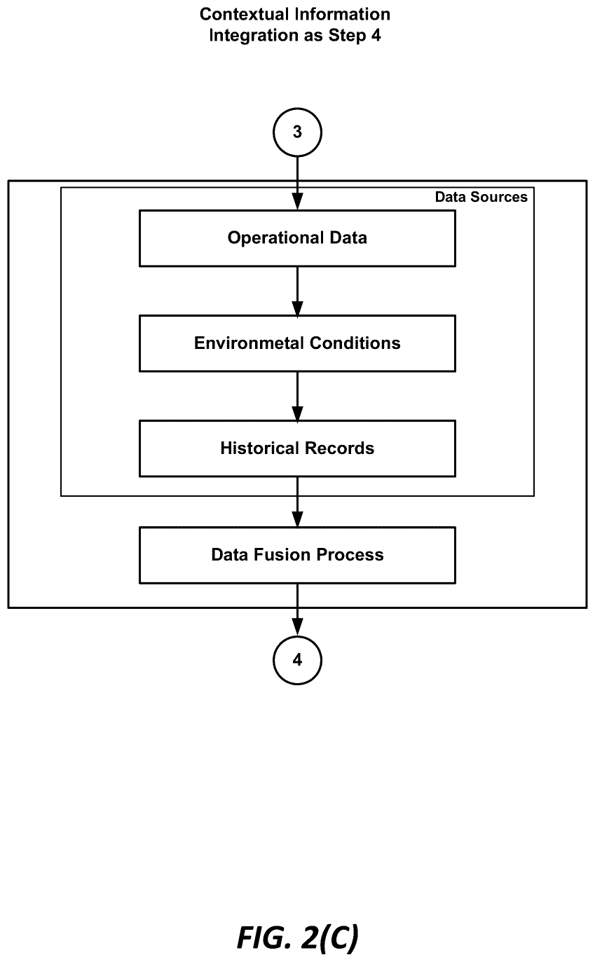

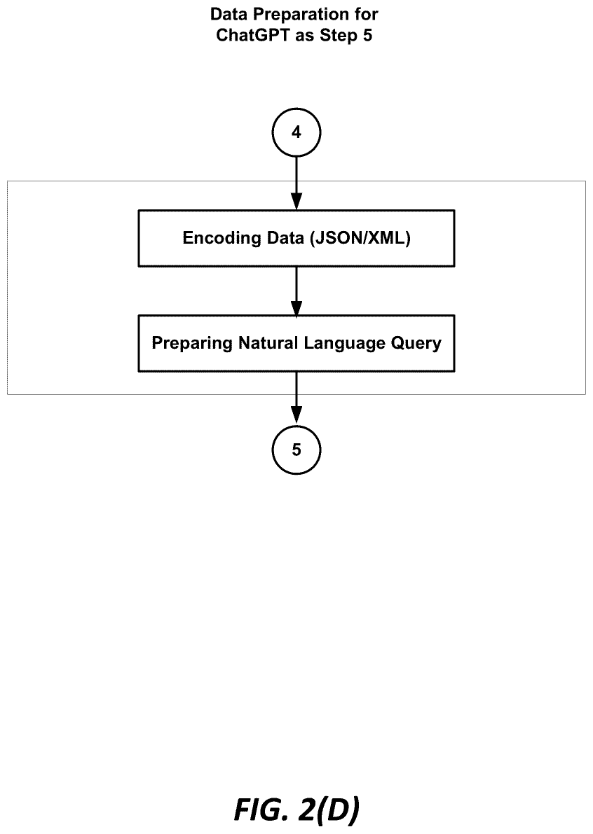

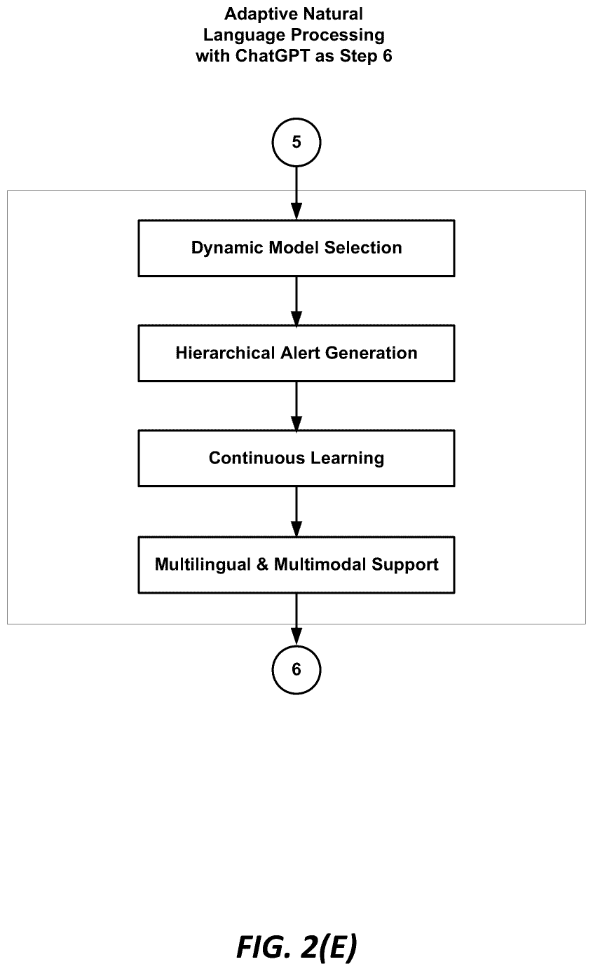

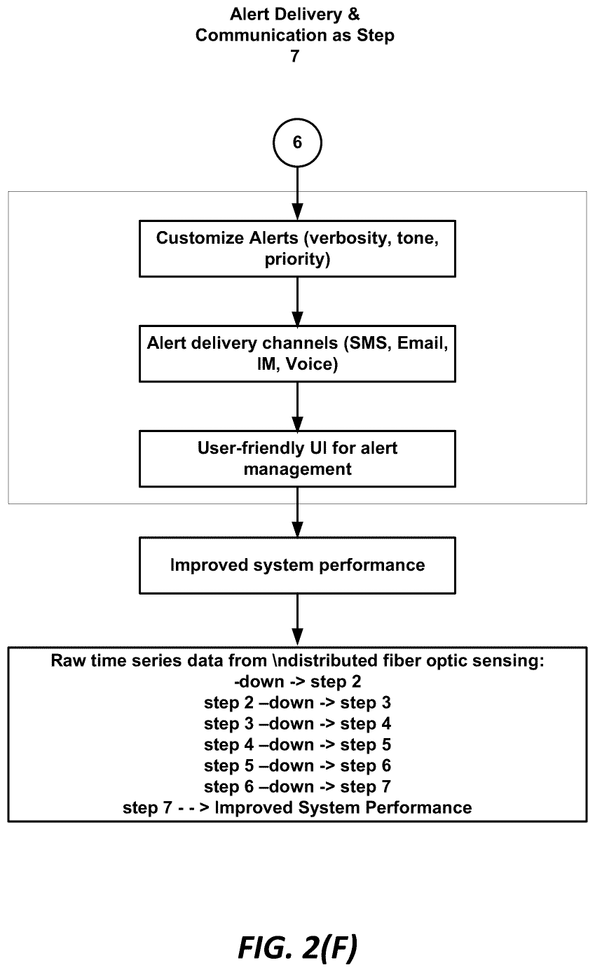

FIG. 2(A)-FIG. 2(F) are a series of schematic flow diagrams showing illustrative high-level operational steps of systems and methods according to aspects of the present disclosure.

### Data Collection and Transmission

The distributed fiber optic sensing system collects high-resolution time series data along the optical fiber by sending an optical signal through the fiber and analyzing the backscattered light. Various sensing techniques, such as Brillouin or Raman scattering, are employed depending on the parameters of interest (e.g., temperature, strain, pressure, or vibration). The collected data is transmitted to the data processing unit.

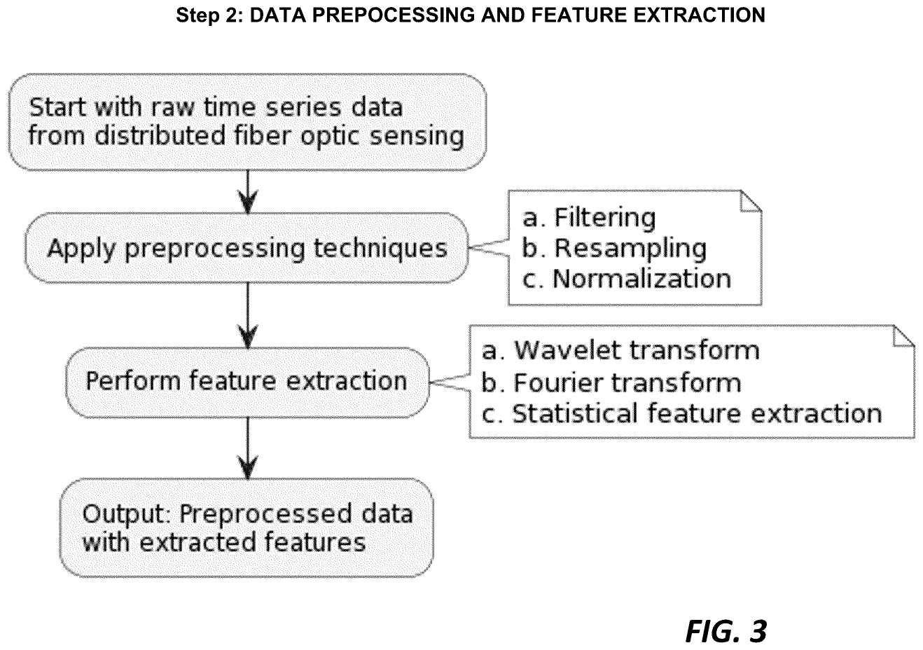

FIG. 3 is a schematic flow diagram showing illustrative data pre-preprocessing and feature extraction operational flow of systems and methods according to aspects of the present disclosure.

### Data Preprocessing and Feature Extraction

The raw time series data collected from the fiber optic sensing system is preprocessed to remove noise, normalize values, and extract relevant features. This preprocessing step may involve techniques such as filtering, smoothing, and data transformation. Feature extraction methods, such as principal component analysis (PCA) or wavelet transformation, can be used to extract informative features from the preprocessed data, which can help identify anomalies more effectively.

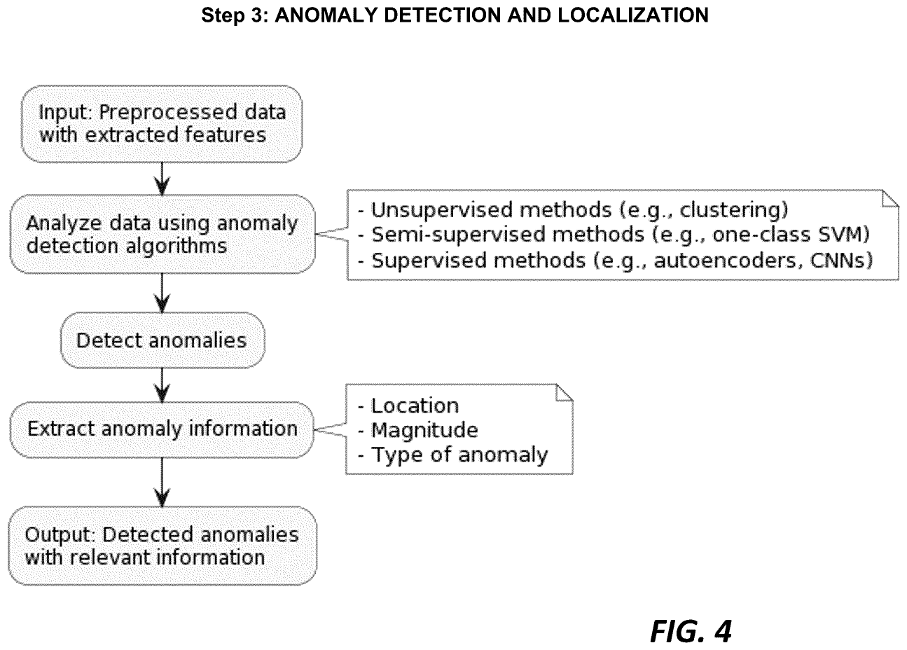

FIG. 4 is a schematic flow diagram showing illustrative anomaly detection and localization operational flow of systems and methods according to aspects of the present disclosure.

### Anomaly Detection and Localization

Anomaly detection algorithms analyze the preprocessed data and extracted features to identify abnormal patterns or deviations from expected values. These algorithms can include unsupervised, semi-supervised, or supervised machine learning methods, such as clustering, one-class support vector machines, or deep learning techniques like autoencoders or convolutional neural networks (CNNs). Detected anomalies are flagged, and relevant information such as location, magnitude, and type of anomaly is extracted.

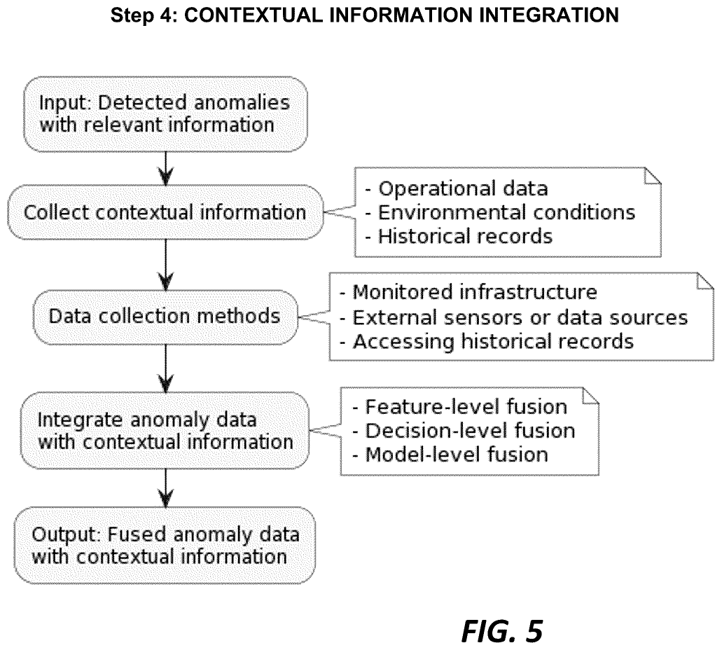

FIG. 5 is a schematic flow diagram showing illustrative contextual information integration operational flow of systems and methods according to aspects of the present disclosure.

### Contextual Information Integration

To enhance the quality and relevance of the natural language alerts, contextual information from external sources or additional sensors can be integrated. This information may include operational data, environmental conditions, or historical records. The data fusion process combines contextual information with the anomaly data, creating a more comprehensive input for ChatGPT.

### Types of Contextual Information

Operational data: Information related to the operation and performance of the monitored infrastructure, such as equipment status, maintenance records, or power consumption. This data can help identify correlations between anomalies and operational events or conditions.

Environmental conditions: Data on external factors that can influence the monitored parameters, such as temperature, humidity, precipitation, or wind speed. Incorporating environmental data can help account for variations in the data caused by these factors and improve anomaly detection accuracy.

Historical records: Past data on similar anomalies, events, or patterns observed in the monitored system. By leveraging historical information, the system can learn from previous events and make better-informed decisions about detected anomalies.

### Data Collection

Contextual information can be collected through various means, such as: directly from the monitored infrastructure's control or monitoring systems; integration with external sensors or data sources, such as weather stations or IoT devices; and accessing historical records stored in databases, spreadsheets, or other data storage systems.

### Data Fusion Process

The data fusion process combines the contextual information with the anomaly data, creating a more comprehensive input for ChatGPT. This can be achieved through various techniques including the following.

Feature-level fusion: Combining the extracted features from both the anomaly data and contextual information into a single feature set.

Decision-level fusion: Integrating the outputs of separate anomaly detection models trained on different data sources (anomaly data and contextual information) to make a final decision.

Model-level fusion: Training a single anomaly detection model using both anomaly data and contextual information as input features.

Incorporating contextual information into the anomaly detection process can enhance the quality and relevance of the natural language alerts generated by ChatGPT. It enables the system to consider external factors and past events when interpreting detected anomalies, leading to more accurate, informative, and actionable alerts.

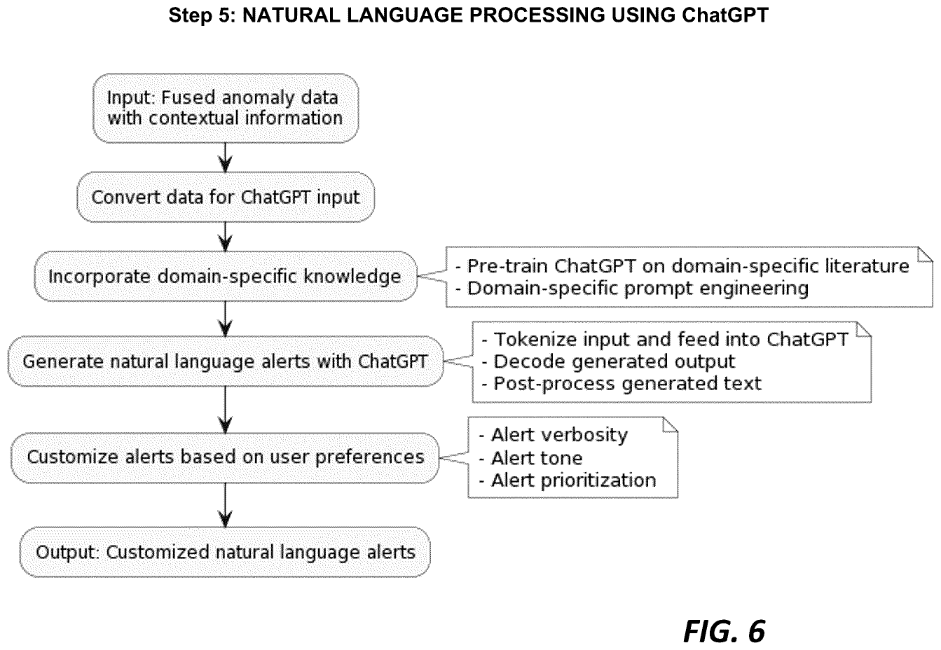

FIG. 6 is a schematic flow diagram showing illustrative natural language processing using ChatGPT flow of systems and methods according to aspects of the present disclosure.

### Natural Language Processing Using ChatGPT

The structured anomaly information is passed to the ChatGPT model as input. ChatGPT processes the input and generates a human-readable, natural language alert that describes the anomaly, its potential consequences, and actionable recommendations for addressing the issue. The output from ChatGPT may resemble a detailed report or a summary of the detected anomaly, depending on the specific implementation and user requirements. Details are presented as follows.

### ChatGPT Input Preparation

Convert the fused anomaly data and contextual information into a structured format that can be easily understood by ChatGPT. This can involve encoding the data into a JSON or XML format or using a custom template to represent the information.

### Incorporating Domain-Specific Knowledge

Integrate domain-specific knowledge into the system to improve the accuracy and relevance of ChatGPT-generated alerts. This can be achieved by: Pre-training ChatGPT on domain-specific literature, such as research papers, manuals, or guidelines, to enhance its understanding of the domain; and Providing domain-specific prompt engineering, which includes designing the input prompts to guide ChatGPT in generating relevant and accurate responses.

### Generating Natural Language Alerts

Use ChatGPT to process the structured input and generate human-readable, natural language alerts. This can involve the following steps: Tokenizing the input and feeding it into ChatGPT; Decoding the generated output from ChatGPT, which might include techniques like beam search, nucleus sampling, or top-k sampling; and Post-processing the generated text to ensure its coherence, accuracy, and relevance.

### Alert Customization

Customize the natural language alerts based on user preferences or specific requirements. This can involve tailoring the alerts in terms of:

Alert verbosity: Adjusting the level of detail provided in the alerts, ranging from concise summaries to more comprehensive explanations.

Alert tone: Modifying the tone of the alerts to suit different audiences or situations, such as using a formal tone for management-level notifications or a more casual tone for field personnel.

Alert prioritization: Prioritizing and grouping alerts based on their severity, urgency, or other relevant criteria, allowing users to focus on the most critical issues first.

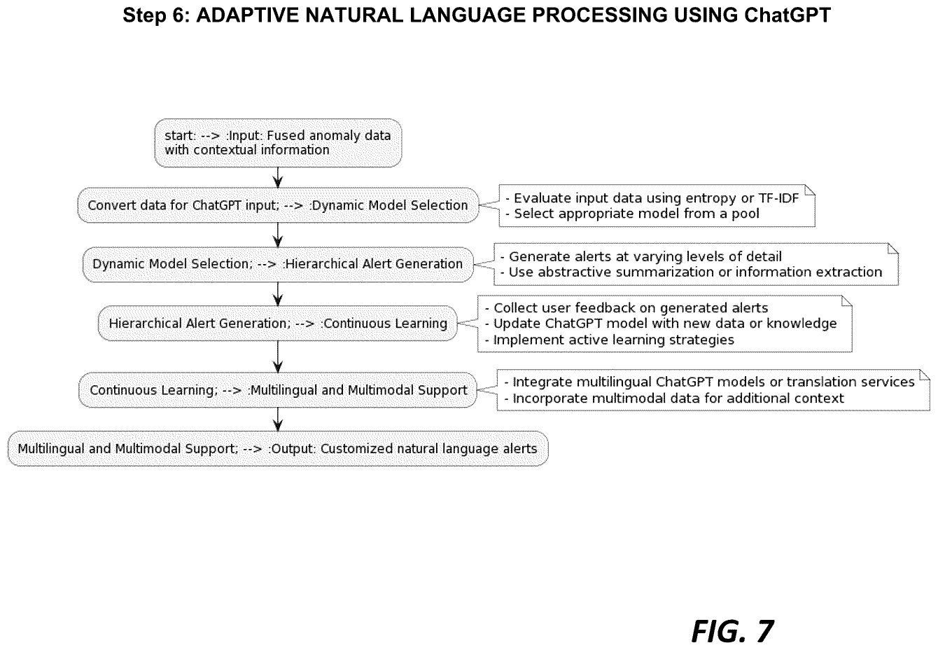

FIG. 7 is a schematic flow diagram showing illustrative adaptive natural language processing using ChatGPT flow of systems and methods according to aspects of the present disclosure.

Adaptive Natural Language Processing with ChatGPT

In this step, the structured input is passed to the ChatGPT model, which processes the information and generates a human-readable, natural language alert with actionable recommendations and potential consequences. The output from ChatGPT can be further refined by applying techniques such as post-processing, summarization, or paraphrasing, to ensure the generated alerts are clear, concise, and relevant. The details are presented as follows.

### Dynamic Model Selection

Implement a system that selects the most appropriate ChatGPT model based on the complexity or specificity of the input data. This can be achieved by: Evaluating the input data using metrics such as entropy or term frequency-inverse document frequency (TF-IDF); and Selecting a model from a pool of pre-trained or fine-tuned ChatGPT models, each with varying levels of domain-specific knowledge, complexity, or data sensitivity.

### Hierarchical Alert Generation

Create a hierarchical alert generation system that outputs alerts at different levels of detail or abstraction. This can involve: Generating multiple alert versions, ranging from high-level summaries to detailed explanations, based on user preferences or requirements; and Using techniques like abstractive summarization or information extraction to generate alerts at varying levels of detail.

### Continuous Learning

Incorporate a continuous learning mechanism that allows the ChatGPT-based system to improve over time by learning from user feedback or newly available data. This can include: Collecting user feedback on generated alerts, such as ratings, comments, or corrections; Regularly updating the ChatGPT model with new data or domain-specific knowledge, either through fine-tuning or by training a new model from scratch; and Implementing active learning strategies to identify areas where the model's performance can be improved and prioritizing these areas for learning.

### Multilingual and Multimodal Support

Enhance the natural language processing capabilities of the system by providing support for multiple languages and modalities. This can involve: Integrating multilingual ChatGPT models or using language translation services to generate alerts in different languages; and incorporating multimodal data, such as images, audio, or video, to provide additional context or information in the generated alerts.

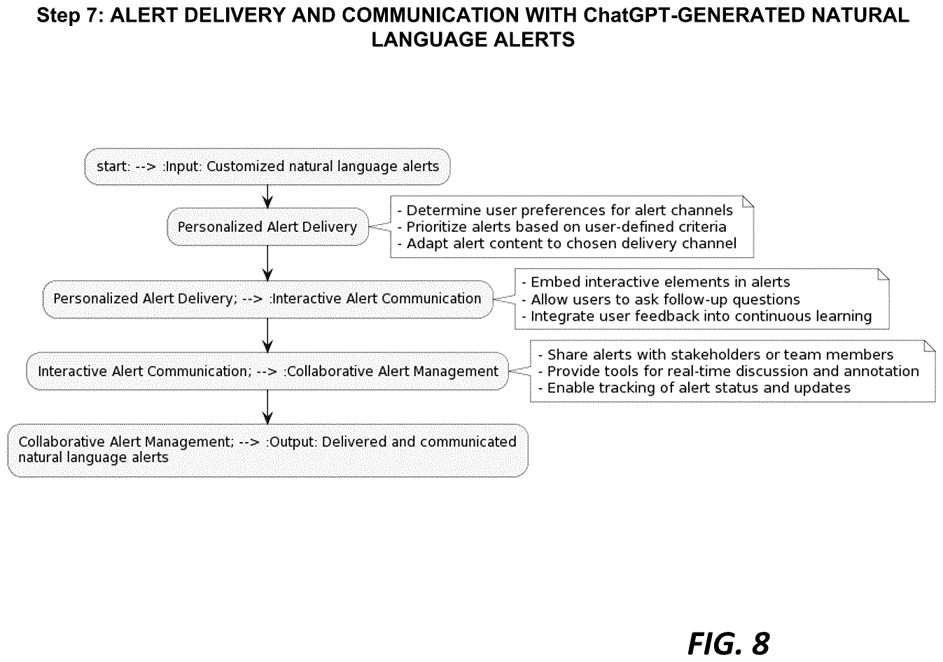

FIG. 8 is a schematic flow diagram showing illustrative alert delivery and communication with ChatGPT-generated natural language alerts flow of systems and methods according to aspects of the present disclosure.

Alert Delivery and Communication with ChatGPT-Generated Natural Language Alerts

The generated natural language alerts are sent to relevant personnel via preferred communication channels or integrated into existing alert management systems, incident response platforms, or visualization tools. The system supports multi-modal communication, allowing alerts to be delivered as text, audio, or visual representations, depending on user preferences and requirements. Details are presented as follows.

### Personalized Alert Delivery

Leverage user preferences and profiles to tailor the delivery of ChatGPT-generated natural language alerts, enhancing user experience and ensuring effective communication. This can involve determining user preferences for alert channels, such as email, SMS, instant messaging platforms, or in-app notifications; prioritizing the delivery of alerts based on user-defined criteria, such as urgency, relevance, or time-sensitive nature of the alerts; and adapting alert content and format to suit the chosen delivery channel, ensuring optimal readability and comprehension.

### Interactive Alert Communication

Enable a dynamic, two-way communication system between users and the OptiSenseGPT system, allowing users to request more information, provide feedback, or take actions directly from the ChatGPT-generated alerts. This can include embedding interactive elements within the natural language alerts, such as buttons, hyperlinks, or quick-reply options, to facilitate user engagement; allowing users to ask follow-up questions or request more details directly from the alert interface, with ChatGPT dynamically generating appropriate responses; and integrating user feedback and responses into the continuous learning process, improving the performance and accuracy of the OptiSenseGPT system.

### Collaborative Alert Management

Facilitate collaboration among users and teams by enabling the sharing and discussion of ChatGPT-generated natural language alerts, promoting collective decision-making and efficient problem-solving. This can involve incorporating features for sharing alerts with relevant stakeholders or team members, either directly through the alert interface or via third-party collaboration platforms; providing tools for real-time discussion, annotation, or commenting on alerts, fostering a collaborative environment for addressing anomalies and related issues; and enabling the tracking of alert status, updates, and resolutions, ensuring that all team members stay informed and can efficiently manage alerts.

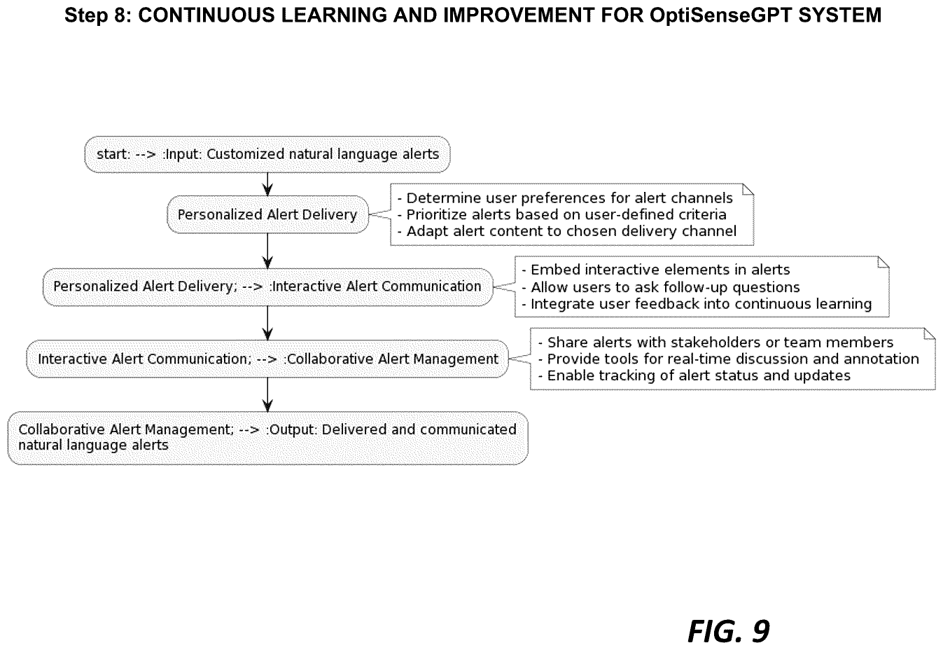

FIG. 9 is a schematic flow diagram showing illustrative continuous learning and improvement for OptiSenseGPT System flow of systems and methods according to aspects of the present disclosure.

### Continuous Learning and Improvement for OptiSenseGPT System

The OptiSenseGPT system continuously monitors the distributed fiber optic sensing data, updating the anomaly detection model and ChatGPT as new data becomes available. This allows the system to adapt to changing conditions and improve its accuracy and efficiency over time. Feedback from users, as well as performance metrics, can be incorporated into the system to further refine the generated alerts, recommendations, and overall system performance.

### User Feedback-Driven Learning

Enhance the performance and accuracy of the OptiSenseGPT system by incorporating user feedback on generated alerts and system interactions. This can involve collecting user feedback in various forms, such as ratings, comments, corrections, or suggestions for improvement; analyzing the collected feedback to identify trends, areas of improvement, and user preferences, adapting the system accordingly; and updating the ChatGPT model or anomaly detection algorithms based on user feedback, ensuring the system remains relevant and accurate.

### Active Learning and Model Adaptation

Implement active learning strategies to identify areas where the OptiSenseGPT system can improve its performance, prioritizing these areas for learning. This can include monitoring system performance metrics, such as false positive rates, false negative rates, or anomaly localization accuracy; identifying instances where the model's confidence is low or its predictions are uncertain, selecting these instances for further analysis or retraining; and continuously updating the ChatGPT model and anomaly detection algorithms with new data or domain-specific knowledge, either through fine-tuning or training new models from scratch.

### Domain-Specific Knowledge Integration

Incorporate domain-specific knowledge into the OptiSenseGPT system to improve its understanding and interpretation of distributed fiber optic sensing data. This can involve pre-training or fine-tuning the ChatGPT model on domain-specific literature, such as research articles, reports, or technical documents related to distributed fiber optic sensing; incorporating domain-specific ontologies or knowledge graphs to provide additional context for the natural language processing tasks; and regularly updating the system with the latest domain-specific knowledge and advancements, ensuring the system stays up-to-date and well-informed.

By focusing on user feedback-driven learning, active learning and model adaptation, and domain-specific knowledge integration, the OptiSenseGPT system continuously evolves and improves its performance in detecting and communicating anomalies. This novelty sets the system apart from traditional approaches and makes it more adaptive, responsive, and efficient in addressing the challenges in distributed fiber optic sensing applications.

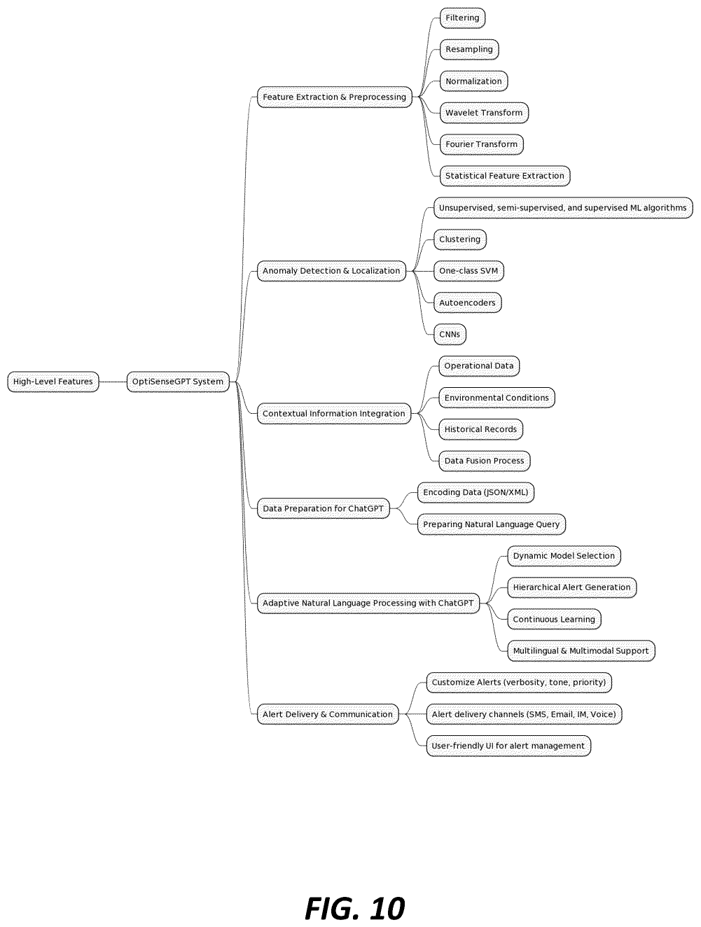

FIG. 10 is a schematic diagram showing illustrative feature hierarchy systems and methods according to aspects of the present disclosure.

While we have presented our inventive concepts and description using specific examples, our invention is not so limited. Accordingly, the scope of our invention should be considered in view of the following claims.

1. An intelligent anomaly detection system for distributed fiber optic sensing (DFOS) applications comprising:
the distributed fiber optic sensing system; and
a natural language processing model configured to generate real-time alerts with actionable recommendations and potential consequences based on anomalies detected in data produced by the DFOS.

2. The system of claim 1 wherein the actionable recommendations are context aware.

3. The system of claim 2 wherein the natural language processing model provides the actionable recommendations based on specific DFOS application and domain.

4. The system of claim 3 wherein the natural language processing model communicates the potential consequences of detected anomalies, raises awareness in operators of potential risks while encouraging timely intervention by the operators.

5. The system of claim 4 comprising external sensors and data sources including internet-of-things sensors and sources.

6. The system of claim 5 wherein the actionable recommendations provided by the natural language processing model are adjustable in terms of verbosity, such that a level of detail provided in the actionable recommendations range from concise summaries to comprehensive explanations.

7. The system of claim 6 wherein the actionable recommendations provided by the natural language processing model are modified by tone to suit different audiences or situations including formal tone for management-level notifications and casual tone for field personnel.

8. The system of claim 7 wherein the natural language processing model is configured to provide the actionable recommendations in multiple languages.

9. The system of claim 8 configured to incorporate multimodal data including images, audio, and video to provide additional context or information with the actionable recommendations.

10. The system of claim 9 configured to interactively communicate between users such that users may request more information, provide feedback, or take actions directly from the natural language processing model generated actionable recommendations.
